(19) United States
(12) Patent Application Publication
(10) Pub. No.: US 2019/0294803 A1
(43) Pub. Date: Sep. 26, 2019

(54) EVALUATION DEVICE, SECURITY PRODUCT EVALUATION METHOD, AND COMPUTER READABLE MEDIUM

(71) Applicant: Mitsubishi Electric Corporation, Tokyo (JP)

(72) Inventors: Takumi YAMAMOTO, Tokyo (JP); Hiroki NISHIKAWA, Tokyo (JP); Keisuke KITO, Tokyo (JP); Kiyoto KAWAUCHI, Tokyo (JP)

(73) Assignee: Mitsubishi Electric Corporation, Tokyo (JP)

(21) Appl. No.: 16/340,981

(22) PCT Filed: Dec. 1, 2016
(86) PCT No.: PCT/JP2016/085767

§ 371 Date: Apr. 10, 2019

(51) Int. Cl. G06F 21/57; G06F 16/22

(52) U.S. Cl. CPC G06F 21/577; G06F 2221/034; G06F 16/22

(57) ABSTRACT

In an evaluation device (100), an attack generation unit (111) generates an attack sample. The attack sample is data for simulating an unauthorized act on a system. A comparison unit (112) compares the attack sample generated by the attack generation unit (111) and a normal state model. The normal state model is data acquired by modeling an authorized act on the system. Based on the comparison result, the comparison unit (112) generates information for generating an attack sample similar to the normal state model, and feeds back the generated information to the attack generation unit (111). A verification unit (113) checks whether the attack sample generated by the attack generation unit (111) satisfies a requirement for simulating an unauthorized act, and verifies, by using the attack sample satisfying the requirement, a detection technique implemented in a security product.

### TECHNICAL FIELD

The present invention relates to evaluation devices, security product evaluation methods, and evaluation programs.

### BACKGROUND ART

In the technique described in Patent Literature 1, an unauthorized program such as malware is modified to create a sample of an unauthorized program that cannot be detected by any existing unauthorized program detection technique such as antivirus software. It is inspected that the newly-generated sample is not detected by the existing product and keeps a malicious function. By using the sample passing the inspection, the unauthorized program detection technique is reinforced.

In the technique described in Patent Literature 2, a byte string of attack data as binary data is made close to normal data by one byte, and the result is inputted to a system, and binary data causing an anomaly in the system is identified. With this, attack data having a feature of the normal data is automatically generated. With this attack data, an anomaly in the system is found, and the system is reinforced.

### CITATION LIST

### Patent Literature

Patent Literature 1: JP 2016-507115

Patent Literature 2: JP 2013-196390

### SUMMARY OF INVENTION

### Technical Problem

In research and development of attack detection techniques, a test attack pattern is required to evaluate a detection function. Attackers in recent years fully research and understand information about an organization as an attack target and then launch an attack so as not to make the attack detection technique aware of it. Internal crimes are also increasing, and it is considered that sophisticated attacks using information about the organization as an attack target will increase in the future.

To address also an attack designed and developed in a sophisticated manner so as to have a feature similar to that in a normal state to avoid detection, evaluation of a security product by using a sophisticated attack sample is required.

However, in the technique described in Patent Literature 1, a normal state of a monitoring target of the unauthorized program detection technique is not considered. Here, the normal state is information about a normal program. In many attack detection techniques, attack detection rules are defined based on a feature of an unauthorized program not included in the normal program so as to prevent the normal program from being detected by mistake. Thus, it is predicted that skilled attackers create an unauthorized program which performs a malicious process in a range of the feature of the normal program. In the technique described in Patent Literature 1, a sample to the extent of this cannot be generated, and it is therefore impossible to reinforce the unauthorized program detection technique so as to allow detection of an unauthorized program which performs a malicious process in the range of the feature of the normal program.

In the technique described in Patent Literature 2, it is not checked whether the generated attack data is established as an attack. For example, it is not checked whether the generated attack data executes an unauthorized program to communicate with a server of the attacker on the Internet. It is predicted that the skilled attacker considers an input which causes the system to perform an unauthorized process only with data in a normal range which does not cause an anomaly in the system. In the technique described in Patent Literature 2, such attack data cannot be generated, and it is therefore impossible to verify the system by using input data which causes the system to perform an unauthorized process only with the data in the normal range which does not cause an anomaly in the system.

An object of the present invention is to evaluation a security product by using a sophisticated attack sample.

### Solution to Problem

An evaluation device according to one aspect of the present invention includes:

an attack generation unit to generate an attack sample, which is data for simulating an unauthorized act on a system;

a comparison unit to compare the attack sample generated by the attack generation unit and a normal state model, which is data acquired by modeling an authorized act on the system, to generate, based on the comparison result, information for generating an attack sample similar to the normal state model, and to feed back the generated information to the attack generation unit; and

a verification unit to check whether the attack sample generated by the attack generation unit by reflecting the information fed back from the comparison unit satisfies a requirement for simulating the unauthorized act and to verify, by using the attack sample satisfying the requirement, a detection technique implemented in a security product for detecting the unauthorized act.

### Advantageous Effects of Invention

According to the present invention, a sophisticated attack sample in which a function predicted to be intended by an attacker is kept can be generated. Thus, by using the sophisticated attack sample, a security product can be evaluated.

### BRIEF DESCRIPTION OF DRAWINGS

FIG. 1 is a block diagram illustrating the configuration of an evaluation device according to Embodiment 1.

FIG. 2 is a block diagram illustrating the configuration of an attack generation unit of the evaluation device according to Embodiment 1.

FIG. 3 is a block diagram illustrating the configuration of a comparison unit of the evaluation device according to Embodiment 1.

FIG. 4 is a block diagram illustrating the configuration of a verification unit of the evaluation device according to Embodiment 1.

FIG. 5 is a flowchart illustrating the operation of the evaluation device according to Embodiment 1.

FIG. 6 is a flowchart illustrating the operation of the attack generation unit of the evaluation device according to Embodiment 1.

FIG. 7 is a flowchart illustrating the operation of the comparison unit of the evaluation device according to Embodiment 1.

FIG. 8 is a flowchart illustrating a process procedure of step S36 of FIG. 7.

FIG. 9 is a flowchart illustrating the operation of the verification unit of the evaluation device according to Embodiment 1.

FIG. 10 is a flowchart illustrating a process procedure of step S51 of FIG. 9.

FIG. 11 is a block diagram illustrating the configuration of an evaluation device according to Embodiment 2.

FIG. 12 is a block diagram illustrating the configuration of a model generation unit of the evaluation device according to Embodiment 2.

FIG. 13 is a flowchart illustrating the operation of the model generation unit of the evaluation device according to Embodiment 2.

### DESCRIPTION OF EMBODIMENTS

In the following, embodiments of the present invention are described by using the drawings. In each drawing, identical or corresponding portions are provided with the same reference characters. In the description of the embodiments, description of identical or corresponding portions is omitted or simplified as appropriate. Note that the present invention is not limited to the embodiments described in the following, but can be variously modified as required. For example, of the embodiments described in the following, two or more embodiments may be combined and implemented. Alternatively, of the embodiments described in the following, one embodiment or a combination of two or more embodiments may be partially implemented.

### Embodiment 1

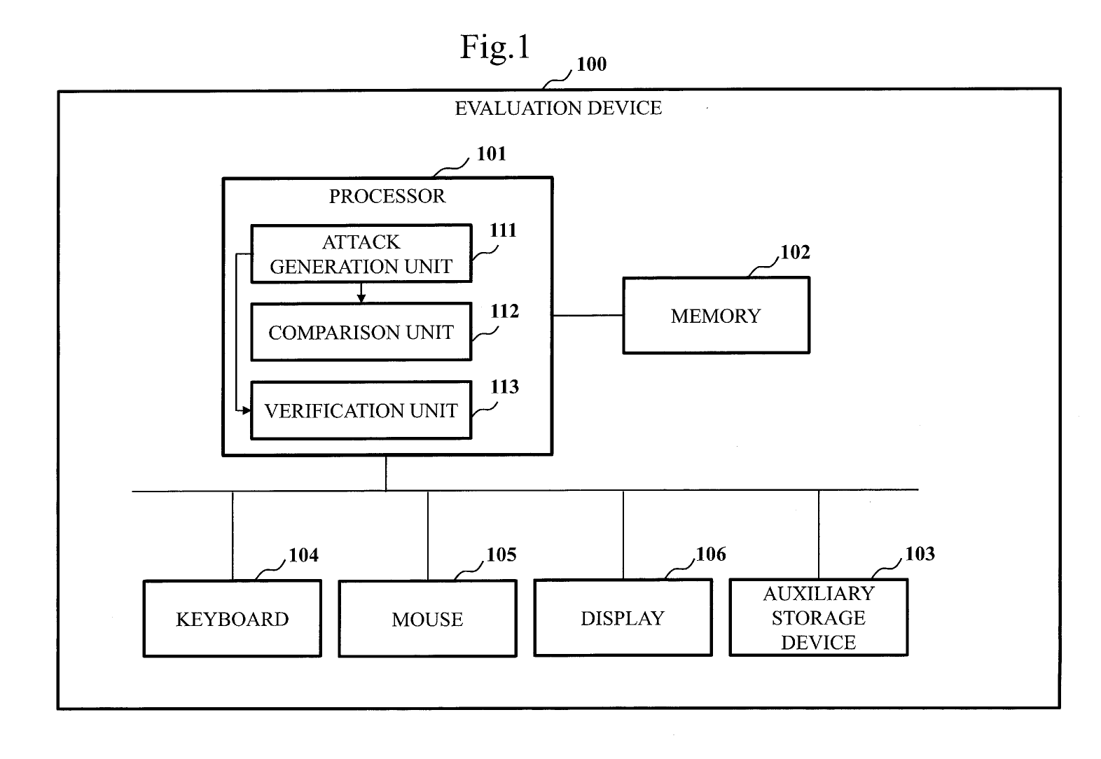

The present embodiment is described by using FIG. 1 to FIG. 10.

***Description of Configuration***

With reference to FIG. 1, the configuration of an evaluation device 100 according to the present embodiment is described.

The evaluation device 100 is a computer. The evaluation device 100 includes a processor 101 and also other pieces of hardware such as a memory 102, an auxiliary storage device 103, a keyboard 104, a mouse 105, and a display 106. The processor 101 is connected to the other pieces of hardware via signal lines to control the other pieces of hardware.

The evaluation device 100 includes an attack generation unit 111, a comparison unit 112, and a verification unit 113 as functional components. The functions of the attack generation unit 111, the comparison unit 112, and the verification unit 113 are implemented by software.

The processor 101 is an IC which performs various processes. “IC” is an abbreviation for Integrated Circuit. The processor 101 is, for example, a CPU. “CPU” is an abbreviation for Central Processing Unit.

The memory 102 is one type of storage medium. The memory 102 is, for example, a flash memory or RAM. “RAM” is an abbreviation for Random Access Memory.

The auxiliary storage device 103 is one type of recording medium different from the memory 102. The auxiliary storage device 103 is, for example, a flash memory or HDD. “HDD” is an abbreviation for Hard Disk Drive.

The evaluation device 100 may include, together with the keyboard 104 and the mouse 105 or in place of the keyboard 104 and the mouse 105, another input device such as a touch panel.

The display 106 is, for example, an LCD. “LCD” is an abbreviation for Liquid Crystal Display.

The evaluation device 100 may include a communication device as hardware.

The communication device includes a receiver which receives data and a transmitter which transmits data. The communication device is, for example, a communication chip or NIC. “NIC” is an abbreviation for Network Interface Card.

In the memory 102, an evaluation program is stored, which is a program for achieving the functions of the attack generation unit 111, the comparison unit 112, and the verification unit 113. The evaluation program is read to the processor 101 and is executed by the processor 101. An OS is also stored in the memory 102. “OS” is an abbreviation of Operating System. While executing the OS, the processor 101 executes the evaluation program. Note that the evaluation program may be partially or entirely incorporated in the OS.

The evaluation program and the OS may be stored in the auxiliary storage device 103. The evaluation program and the OS stored in the auxiliary storage device 103 are loaded to the memory 102 and executed by the processor 101.

The evaluation device 100 may include a plurality of processors which replaces the processor 101. The plurality of these processors share the execution of the evaluation program. As with the processor 101, each of the processors is an IC which performs various processes.

Information, data, signal values, and variable values indicating the results of processes of the attack generation unit 111, the comparison unit 112, and the verification unit 113 are stored in the memory 102, the auxiliary storage device 103, or a register or cache memory in the processor 101.

The evaluation program may be stored in a portable recording medium such as a magnetic disk or optical disk.

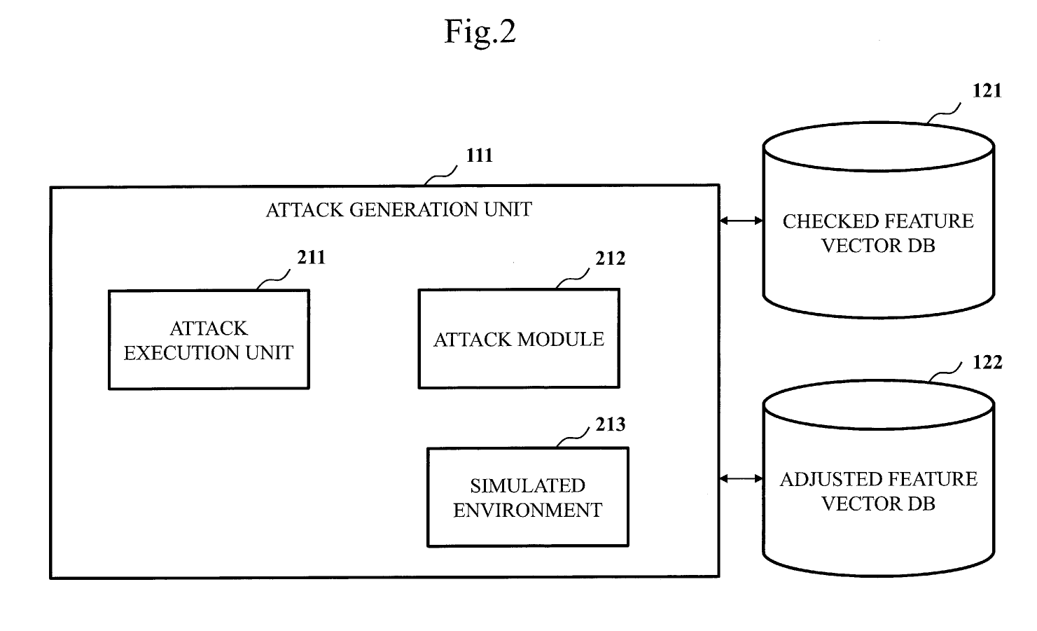

With reference to FIG. 2, the configuration of the attack generation unit 111 is described.

The attack generation unit 111 has an attack execution unit 211, an attack module 212, and a simulated environment 213. Note that the attack generation unit 111 may have a virtual environment in place of the simulated environment 213.

The attack generation unit 111 accesses a checked feature vector database 121 and an adjusted feature vector database 122. The checked feature vector database 121 and the adjusted feature vector database 122 are constructed in the memory 102 or on the auxiliary storage device 103.

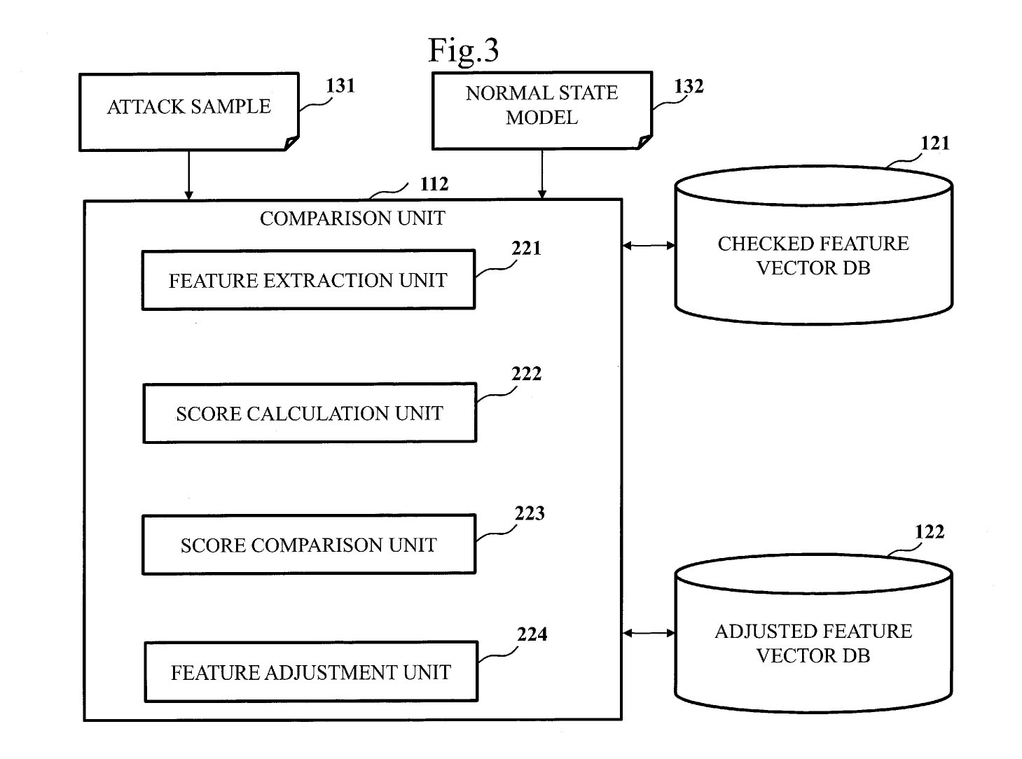

With reference to FIG. 3, the configuration of the comparison unit 112 is described.

The comparison unit 112 has a feature extraction unit 221, a score calculation unit 222, a score comparison unit 223, and a feature adjustment unit 224.

The comparison unit 112 accesses the checked feature vector database 121 and the adjusted feature vector database 122.

The comparison unit 112 receives an input of an attack sample 131 from the attack generation unit 111. The comparison unit 112 reads a normal state model 132 stored in advance in the memory 102 or the auxiliary storage device 103.

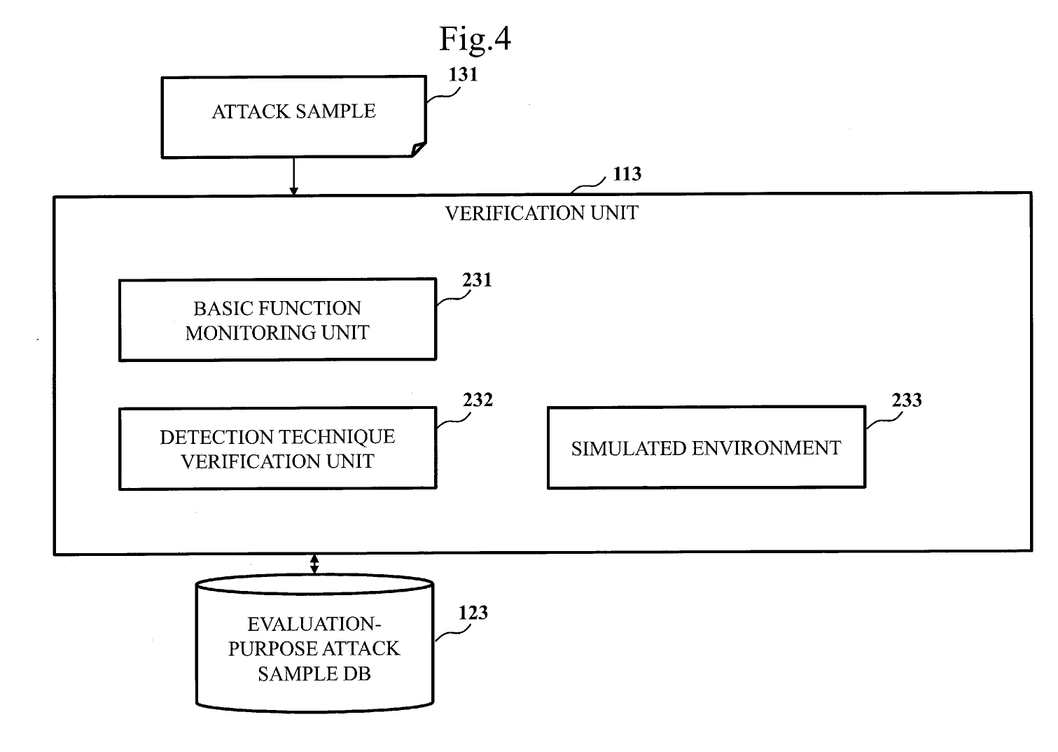

With reference to FIG. 4, the configuration of the verification unit 113 is described.

The verification unit 113 has a basic function monitoring unit 231, a detection technique verification unit 232, and a simulated environment 233. Note that the verification unit 113 may share, with the attack generation unit 111, the simulated environment 213 in place of the unique simulated environment 233. The verification unit 113 may have a virtual environment in placement of the simulated environment 233.

The verification unit 113 accesses an evaluation-purpose attack sample database 123. The evaluation-purpose attack sample database 123 is constructed in the memory 102 or on the auxiliary storage device 103.

The verification unit 113 receives an input of the attack sample 131 from the attack generation unit 111.

***Description of Operation***

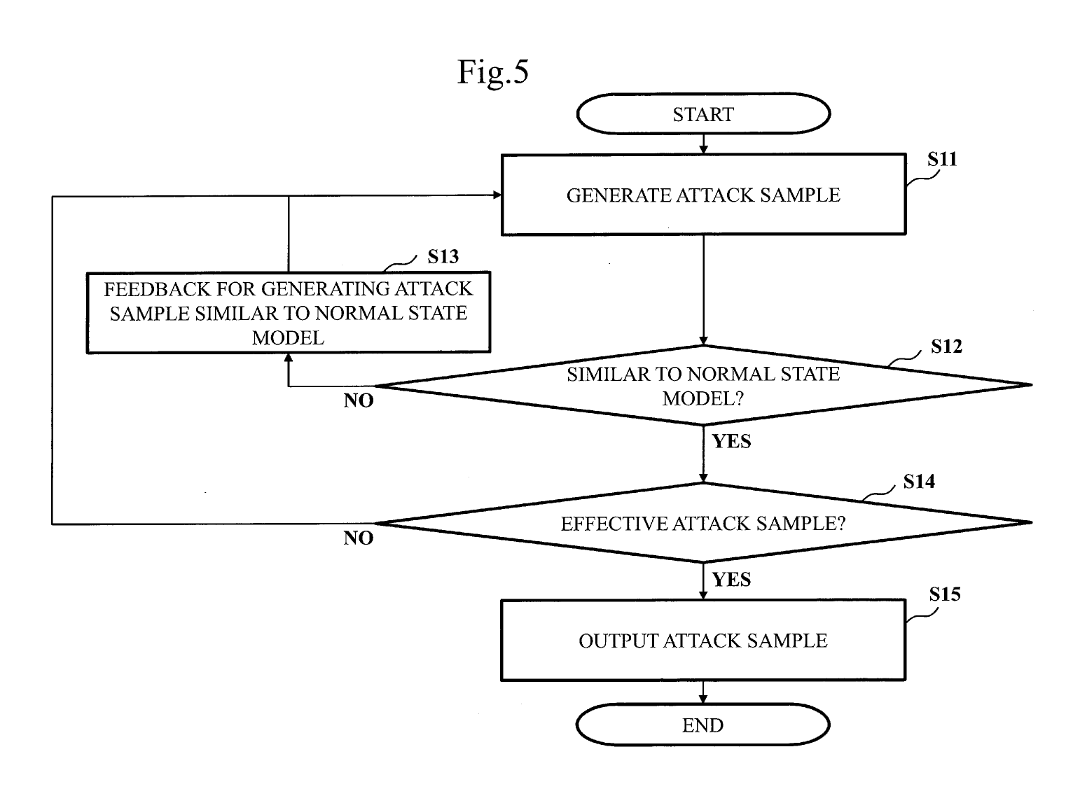

With reference to FIG. 5 to FIG. 10, the operation of the evaluation device 100 according to the present embodiment is described. The operation of the evaluation device 100 corresponds to a security product evaluation method according to the present embodiment.

FIG. 5 illustrates a flow of operation of the evaluation device 100.

At step S11, the attack generation unit 111 generates the attack sample 131. The attack sample 131 is data for simulating an unauthorized act on a system that can become an attack target. The unauthorized act is an act that corresponds to an attack.

Specifically, the attack generation unit 111 generates the attack sample 131 to be applied to a security product as an evaluation target by using the attack module 212.

The attack module 212 is a program which simulates an unauthorized act. The attack module 212 is a program which operates on the simulated environment 213, thereby generating the attack sample 131 to be monitored by the security product as an evaluation target.

The security product as an evaluation target is a tool having implemented therein at least any of detection techniques such as a log monitoring technique, an unauthorized mail detection technique, a suspicious communication monitoring technique, and unauthorized file detection technique. It does not matter whether the tool is at a cost or no cost. Also, it does not matter whether the detection technique is an existing technique or a new technique. That is, a verification target of the verification unit 113, which will be described further below, can include not only a detection technique uniquely implemented in the security product as an evaluation target but also a general detection technique.

The log monitoring technique is a technique of monitoring a log and detecting an anomaly in the log. A specific example of a security product having the log monitoring technique implemented therein is a SIEM product. “SIEM” is an abbreviation for Security Information and Event Management. When the detection technique implemented in the security product as an evaluation target is the log monitoring technique, a program for executing a series of processes intended by an attacker is used as the attack module 212. Examples of the processes intended by the attacker are file manipulations, user authentication, program startup, and uploading of information to outside.

The unauthorized mail detection technique is a technique of detecting an unauthorized mail such as a spam mail or targeted attack mail. When the detection technique implemented in the security product as an evaluation target is the unauthorized mail detection technique, a program for generating a text of an unauthorized mail is used as the attack module 212.

The suspicious communication monitoring technique is a technique of detecting or preventing an unauthorized entry. Specific examples of a security product having the suspicious communication monitoring technique implemented therein are IDS and IPS. “IDS” is an abbreviation for Intrusion Detection System. “IPS” is an abbreviation for Intrusion Prevention System. When the detection technique implemented in the security product as an evaluation target is the suspicious communication monitoring technique, a program for exchanging a command to and from the C & C server or a program for executing a process of receiving a command from the C & C server to perform a process corresponding to the command is used as the attack module 212. “C & C” is an abbreviation for Command and Control.

The unauthorized file detection technique is a technique of detecting an unauthorized file such as a virus. A specific example of a security product having the unauthorized file detection technique implemented therein is antivirus software. When the detection technique implemented in the security product as an evaluation target is the unauthorized file detection technique, any of programs for executing a program, deleting a file, exchanging with the C & C server, uploading a file, and so forth is used as the attack module 212. Alternatively, a program for generating a document file having a script for performing any process described above embedded therein is used.

The attack module 212 may be an open-source, commercially available, or dedicatedly-prepared one as long as the features of the attack can be freely adjusted by changing an attack parameter.

At step S12, the comparison unit 112 compares the attack sample 131 generated by the attack generation unit 111 and the normal state model 132. The normal state model 132 is data acquired by modeling an authorized act on a system that can be an attack target. The authorized act is an act that does not correspond to an attack.

Specifically, the comparison unit 112 measures a similarity between the acquired attack sample 131 and the normal state model 132 prepared in advance. When the similarity is smaller than a predetermined threshold, the process at step S13 is performed. When the similarity is equal to or larger than the threshold, the process at step S14 is performed.

The normal state model 132 is a model which defines a normal state of information monitored by the security product as an evaluation target.

When the detection technique implemented in the security product as an evaluation target is the log monitoring technique, information monitored by the log monitoring technique is a log, and a log generated when an environment where the log is acquired is normally operating is defined as being in a normal state. The environment where the log is acquired is a system that can be an attack target.

When the detection technique implemented in the security product as an evaluation target is the unauthorized mail detection technique, information monitored by the unauthorized mail detection technique is a mail, and a mail normally exchanged in an environment where the mail is acquired is defined as being in a normal state. The environment where the mail is acquired is a system that can be an attack target.

When the detection technique implemented in the security product as an evaluation target is the suspicious communication monitoring technique, information monitored by the suspicious communication monitoring technique is communication data, and communication data normally exchanged in an environment where the communication data flows is defined as being in a normal state. The environment where the communication data flows is a system that can be an attack target.

When the detection technique implemented in the security product as an evaluation target is the unauthorized file detection technique, information monitored by the unauthorized file detection technique is a file, and a file used as a normal file in an environment where the file is stored is defined as being in a normal state. The environment where the file is stored is a system that can be an attack target.

At step S13, based on the comparison result between the attack sample 131 and the normal state model 132, the comparison unit 112 generates information for generating an attack sample 131 similar to the normal state model 132. The comparison unit 112 feeds back the generated information to the attack generation unit 111.

That is, the comparison unit 112 feeds back, to the attack generation unit 111, information for creating the attack sample 131 similar to the normal state model 132. Then, the process at step S11 is again performed and, based on the fed-back information, the attack generation unit 111 adjusts the attack sample 131. Adjustment of the attack sample 131 is achieved by changing an attack parameter inputted to the attack module 212.

When the detection technique implemented in the security product as an evaluation target is the log monitoring technique, the frequency and interval of trying a process intended by the attacker, the size of information to be exchanged, and so forth can be attack parameters. Examples of the processes intended by the attacker are file manipulations, user authentication, program startup, and uploading of information to outside. An example of the size of information to be exchanged is the size of information to be uploaded.

When the detection technique implemented in the security product as an evaluation target is the unauthorized mail detection technique, the title and the contents of the body and the type of a keyword of a mail, the number of times of mail exchange, and so forth can be attack parameters.

When the detection technique implemented in the security product as an evaluation target is the suspicious communication monitoring technique, the type of a protocol, the originator, the destination, the communication data size, communication frequency, communication interval, and so forth can be attack parameters.

When the detection technique implemented in the security product as an evaluation target is the unauthorized file detection technique, the size of an unauthorized file, whether the file is encrypted, whether padding of meaningless data or padding of meaningless instruction is present, the number of times of obfuscation, and so forth can be attack parameters.

At step S14, the verification unit 113 checks whether the attack sample 131 generated by the attack generation unit 111 by reflecting the information fed back from the comparison unit 112 satisfies a requirement for simulating an unauthorized act. By using the attack sample 131 satisfying the requirement, the verification unit 113 verifies the detection technique for detecting an unauthorized act implemented in the security product.

That is, the verification unit 113 verifies whether the attack sample 131 similar to the normal state model 132 keeps an attack function.

When the detection technique implemented in the security product as an evaluation target is the log monitoring technique, it is checked that a process intended by the attacker is successful by the attack which has generated the log. Examples of the process intended by the attacker are file manipulations, user authentication, program startup, and uploading of information to outside. It is also checked that these processes are not detected by the detection technique.

When the detection technique implemented in the security product as an evaluation target is the unauthorized mail detection technique, it is checked that a person to which the generated unauthorized mail has been sent actually clicks by mistake a URL on the body of the unauthorized mail or an attached file. It is also checked that this unauthorized mail is not detected by the detection technique. “URL” is an abbreviation for Uniform Resource Locator.

When the detection technique implemented in the security product as an evaluation target is the suspicious communication monitoring technique, it is checked that a process intended by the attacker is successful by attack communication. Examples of the process intended by the attacker are RAT manipulations, exchanges with the C & C server, and file uploading. “RAT” is an abbreviation for Remote Administration Tool. It is also checked that attack communication is not detected by the detection technique.

When the detection technique implemented in the security product as an evaluation target is the unauthorized file detection technique, it is checked that a process intended by the attacker is successful by the generated unauthorized file. Examples of the process intended by the attacker are program execution, file deletion, communication with the C & C server, and file uploading. It is also checked that the file is not detected by the detection technique.

When the attack function is kept, the process at step S15 is performed. When the attack function is not kept, the process at step S11 is performed again, and the attack generation unit 111 generates a new attack sample 131.

At step S15, the verification unit 113 outputs, as an evaluation-purpose attack sample 131, the attack sample 131 satisfying the requirement for simulating an unauthorized act and not detected by the detection technique implemented in the security product.

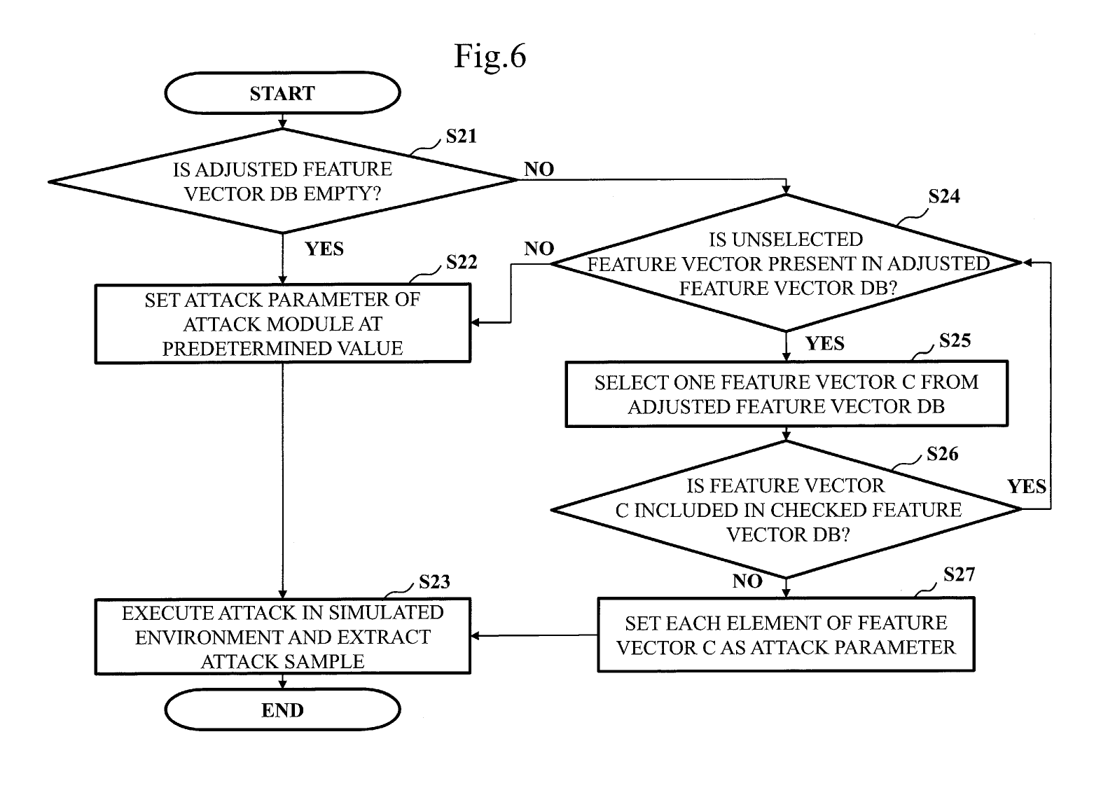

FIG. 6 illustrates a flow of operation of the attack generation unit 111.

In the present embodiment, the attack execution unit 211 generates the attack sample 131 by executing the attack module 212. As specifically described further below, if there is non-reflected information generated by the comparison unit 112, the attack execution unit 211 sets a parameter of the attack module 212 in accordance with the non-reflected information, and then executes the attack module 212.

At step S21, the attack execution unit 211 checks whether the adjusted feature vector database 122 is empty.

The adjusted feature vector database 122 is a database for registering a feature vector of the attack sample 131 having a feature adjusted so as to be close to the normal state model 132. The feature vector is a vector having information regarding one or more types of feature. The number of dimensions of the feature vector matches the number of features represented by the feature vector. As described further below, the feature vector adjusted in the comparison unit 112 is registered in the adjusted feature vector database 122.

The features refer to various types of information for identify the state.

When the detection technique implemented in the security product as an evaluation target is the log monitoring technique, the frequency and interval of trying a process intended by the attacker, the size of information to be exchanged, and so forth can be features.

When the detection technique implemented in the security product as an evaluation target is the unauthorized mail detection technique, the title and the contents of the body and the type of a keyword of a mail, the number of times of mail exchange, and so forth can be features.

When the detection technique implemented in the security product as an evaluation target is the suspicious communication monitoring technique, the type of a protocol, the originator, the destination, the communication data size, communication frequency, communication interval, and so forth can be features.

When the detection technique implemented in the security product as an evaluation target is the unauthorized file detection technique, the size of an unauthorized file, whether the file is encrypted, whether padding of meaningless data or padding of meaningless instruction is present, the number of times of obfuscation, and so forth can be features.

In this manner, in the present embodiment, the feature corresponds to the attack parameter to be used by the attack generation unit 111.

When the adjusted feature vector database 122 is empty, the process at step S22 is performed. When not empty, the process at step S24 is performed.

At step S22, the attack execution unit 211 sets an attack parameter of the attack module 212 by following a predetermined rule. In the predetermined rule, it is defined that a predetermined default value is set or a random value is set.

At step S23, the attack execution unit 211 executes the attack module 212 having the attack parameter set therein in the simulated environment 213 to create the attack sample 131. Then, the operation of the attack generation unit 111 ends.

At step S24, the attack execution unit 211 checks whether an unselected feature vector is present in the adjusted feature vector database 122. If an unselected feature vector is not present, the process at step S22 is performed. If an unselected feature vector is present, the process at step S25 is performed.

At step S25, the attack execution unit 211 selects one feature vector C=(c1, c2, . . . , cn) from the adjusted feature vector database 122. The feature vector C is a vector having information regarding n types of feature. The feature is represented as ci (i=1, . . . , n).

At step S26, the attack execution unit 211 checks whether the selected feature vector C is included in the checked feature vector database 121. The checked feature vector database 121 is a database for registering an already checked feature vector. As described further below, the feature vector checked in the verification unit 113 is registered in the checked feature vector database 121.

If the feature vector C is included in the checked feature vector database 121, the process at step S24 is performed again. If not included, the process at step S27 is performed.

At step S27, the attack execution unit 211 sets each element of the feature vector C to a corresponding attack parameter of the attack module 212. Then, the process at step S23 is performed.

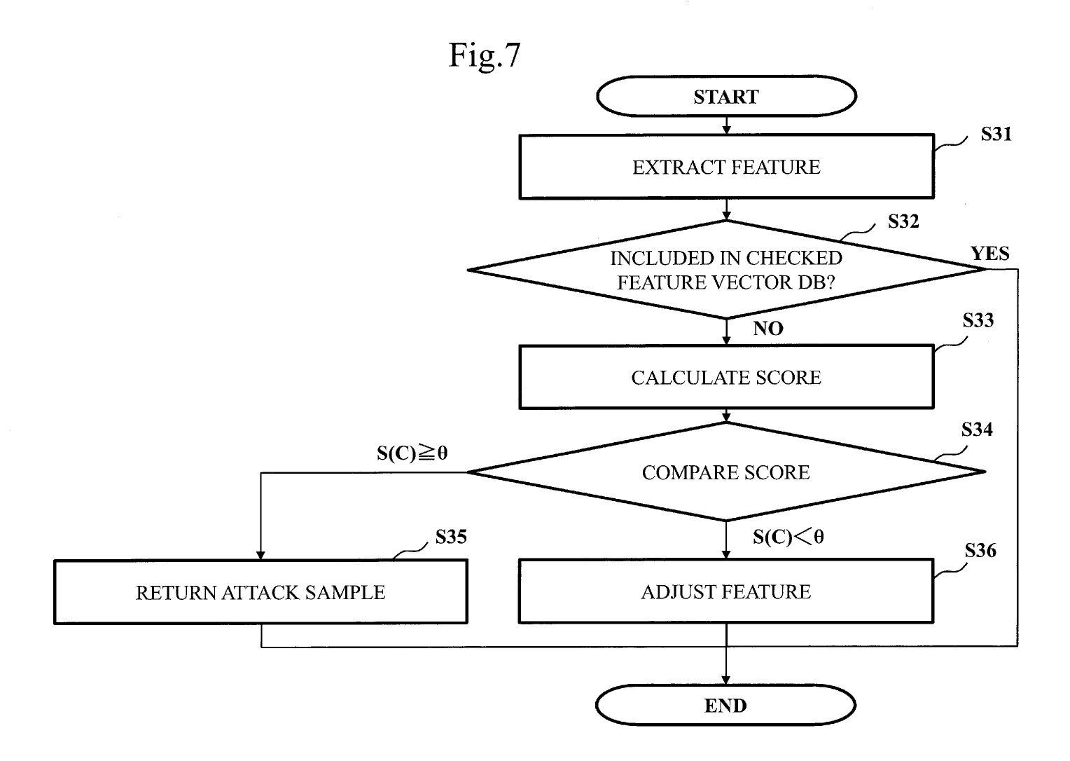

FIG. 7 illustrates a flow of operation of the comparison unit 112.

At step S31, the feature extraction unit 221 extracts the feature of the attack sample 131 generated by the attack generation unit 111.

Specifically, the feature extraction unit 221 extracts, from the attack sample 131, a feature of a type identical to that modeled by the normal state model 132 prepared in advance, and generates a feature vector of the attack sample 131.

At step S32, the feature extraction unit 221 checks whether a feature vector identical to the extracted one is registered in the checked feature vector database 121. If registered, the operation of the comparison unit 112 ends. If not registered, the process at step S33 is performed.

At step S33, the score calculation unit 222 calculates a score indicating a similarity between the feature extracted by the feature extraction unit 221 and the feature of the normal state model 132.

Specifically, the score calculation unit 222 calculates a score from the feature vector of the attack sample 131 generated by the feature extraction unit 221. The score is a numerical value of similarity representing how the attack sample 131 is similar to the normal state model 132 prepared in advance. The score has a higher value when the attack sample 131 is more similar to the normal state model 132 and a lower value when the attack sample 131 is less similar to the normal state model 132.

Here, a certain classifier E is assumed. Using the normal state model 132 prepared by machine learning of information in a normal state in advance, the classifier E calculates a score S(C) with respect to the feature vector C=(c1, c2, . . . , cn) of the given attack sample 131. The score S(C) corresponds to a probability of a predicted value in the classifier E in machine learning.

At step S34, the score comparison unit 223 compares the score S(C) calculated by the score calculation unit 222 with a predetermined threshold θ. When S(C)≥θ holds, the score comparison unit 223 determines that the given attack sample 131 is normal. Then, the process at step S35 is performed. When S(C)<θ holds, the score comparison unit 223 determines that the given attack sample 131 is abnormal. Then, the process at step S36 is performed. That is, when the score calculated by the score calculation unit 222 is smaller than the threshold, the process at step S36 is performed.

At step S35, the score comparison unit 223 returns the attack sample 131. Then, the operation of the comparison unit 112 ends.

At step S36, the feature adjustment unit 224 increases the similarity by adjusting the feature extracted by the feature extraction unit 221. The feature adjustment unit 224 generates information indicating features after adjustment as information to be fed back to the attack generation unit 111.

Specifically, the feature adjustment unit 224 adjusts the feature vector of the attack sample 131 generated by the feature extraction unit 221 so that the given attack sample 131 is determined as normal. The feature adjustment unit 224 registers the adjusted feature vector in the adjusted feature vector database 122. As described further below, an already-used feature vector is not registered in the adjusted feature vector database 122.

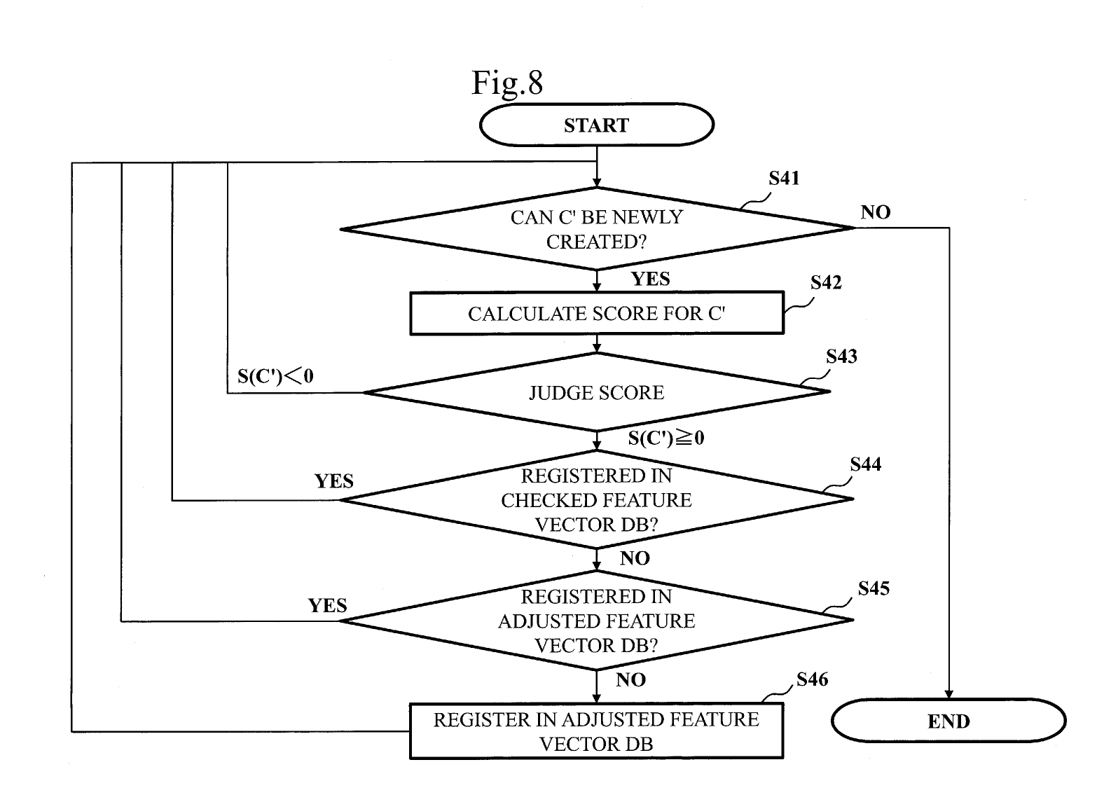

FIG. 8 illustrates a process procedure of step S36. That is, FIG. 8 illustrates a flow of operation of the feature adjustment unit 224.

At step S41, the feature adjustment unit 224 checks whether a new feature vector C′ with the given feature vector C adjusted can be created. Specifically, the feature adjustment unit 224 attempts all combinations of discrete values (LBi≤ci≤UBi) each element of the given feature vector C=(c1, c2, . . . , cn) can take. UBi and LBi respectively represent an upper limit and a lower limit of a range in which a search for the new feature vector C′ is made from the given feature vector C. When attempts on all combinations end, this means that the new feature vector C′ cannot be created. Then, the operation of the feature adjustment unit 224 ends.

At step S42, as for a feature vector C′=(c1+Δ1, c2+Δ2, . . . , cn+Δn) acquired at step S41, the feature adjustment unit 224 calculates a score S(C′) by using the classifier E and the normal state model 132. Note that the feature adjustment unit 224 may cause the score calculation unit 222 to perform the process at step S42.

At step S43, the feature adjustment unit 224 compares the score S(C′) calculated at step S42 and a predetermined threshold θ. When S(C′)≥θ holds, the feature adjustment unit 224 determines that the attack sample 131 becomes normal if adjustment is made by following the feature vector C′. Then, the process at step S44 is performed. When S(C′)<θ holds, the feature adjustment unit 224 determines that the attack sample 131 is still abnormal even if adjustment is made by following the feature vector C′. Then, the process at step S41 is performed again. Note that the feature adjustment unit 224 may cause the score comparison unit 223 to perform the process at step S43.

At step S43, the feature adjustment unit 224 may compare the score S(C′) calculated at step S42 and the score S(C) calculated at step S33. When S(C′)−S(C)>0 holds, the feature adjustment unit 224 determines that the attack sample 131 is improved if adjustment is made by following the feature vector C′. Then, the process at step S44 is performed. When S(C′)−S(C)≤0 holds, the feature adjustment unit 224 determines that the attack sample 131 is not improved even if adjustment is made by following the feature vector C′. Then, the process at step S41 is performed again.

At step S44, the feature adjustment unit 224 checks whether the feature vector C′ has already been registered in the checked feature vector database 121. If registered, the process at step S41 is performed again. If not registered, the process at step S45 is performed.

At step S45, the feature adjustment unit 224 checks whether the feature vector C′ has been registered in the adjusted feature vector database 122. If registered, the process at step S41 is performed again. If not registered, the process at step S46 is performed.

At step S46, the feature adjustment unit 224 registers the feature vector C′ in the adjusted feature vector database 122. Then, the process at step S41 is performed again.

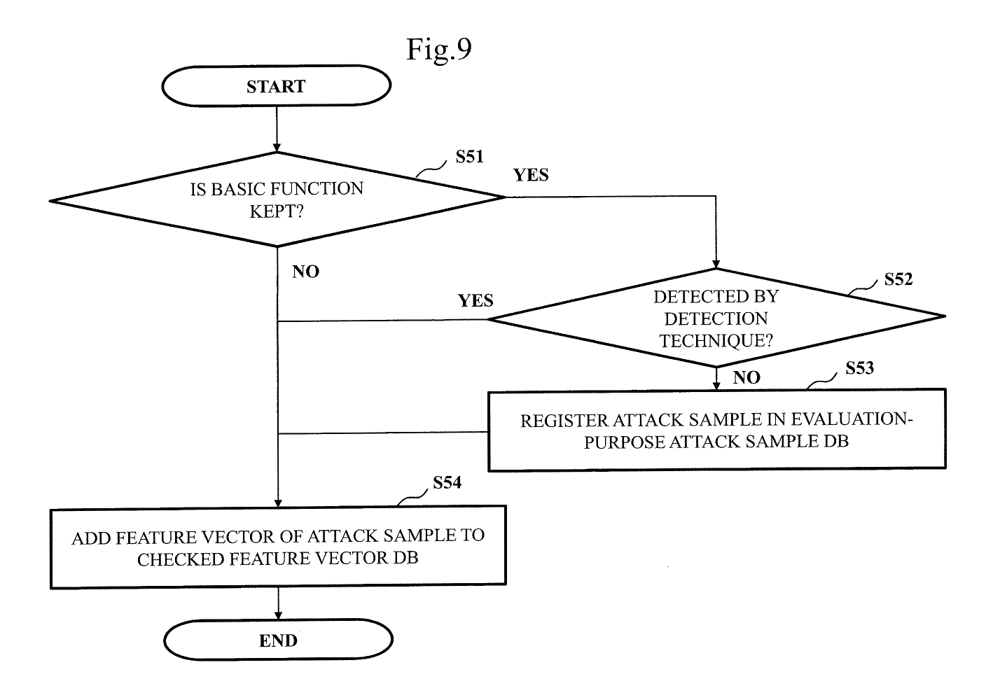

FIG. 9 illustrates a flow of operation of the verification unit 113.

At step S51, the basic function monitoring unit 231 checks whether the attack sample 131 generated by the attack generation unit 111 satisfies a requirement for simulating an unauthorized act.

Specifically, the basic function monitoring unit 231 executes, on the simulated environment 213, an attack of the attack sample 131 generated by the attack execution unit 211 of the attack generation unit 111 to check whether the attack sample 131 keeps the basic function. If it keeps the basic function, the process at step S52 is performed. If it does not keep the basic function, the process at step S54 is performed. Note that, for safety, a virtual environment may be used in place of the simulated environment 213.

At step S52, the detection technique verification unit 232 simulates the unauthorized act by using the attack sample 131 satisfying the requirement checked at step S51. The detection technique verification unit 232 checks whether the simulated act has been detected by the detection technique implemented in the security product. If not detected, the process at step S53 is performed. If detected, the process at step S54 is performed.

That is, by using the detection technique implemented in the security product, the detection technique verification unit 232 checks whether the attack sample 131 can be detected. If it cannot be detected, the process at step S53 is performed. If it can be detected, the process at step S54 is performed.

At step S53, the detection technique verification unit 232 registers the attack sample 131 used at step S52 as an evaluation-purpose attack sample 131 in the evaluation-purpose attack sample database 123.

At step S54, the detection technique verification unit 232 adds the feature vector of the attack sample 131 to the checked feature vector database 121.

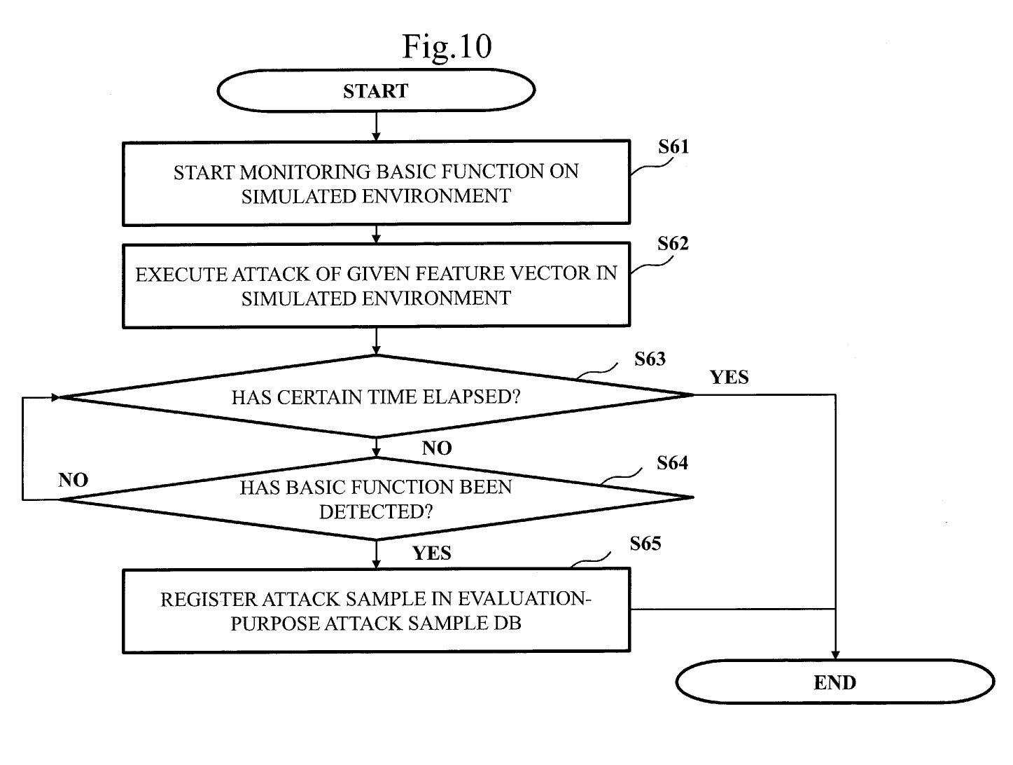

FIG. 10 illustrates a process procedure of step S51. That is, FIG. 10 illustrates a flow of operation of the basic function monitoring unit 231.

At step S61, the basic function monitoring unit 231 starts monitoring the basic functions on the simulated environment 213.

When the detection technique implemented in the security product as an evaluation target is the log monitoring technique, it is monitored whether the basic function is exerted by an attack causing a log. Examples of the basic function are file manipulations, user authentication, program startup, and uploading of information to outside. Specifically, the basic function monitoring unit 231 monitors a log such as Syslog and communication log to determine whether a log regarding the basic function is present. That is, the basic function monitoring unit 231 operates as a program for searching information in the log by following definitions determined in advance.

When the detection technique implemented in the security product as an evaluation target is the unauthorized mail detection technique, it is monitored whether the basic function is exerted by a generated unauthorized mail. An example of the basic function is that a person to which the mail has been sent actually clicks by mistake a URL on the body of the unauthorized mail or an attached file. Specifically, as part of a training for addressing suspicious mails in an organization, the basic function monitoring unit 231 sends a generated unauthorized mail to a person in the organization and monitors whether a URL on the body of the unauthorized mail or an attached file is actually clicked. In the attached file, a script which is programmed so that a specific URL is accessed when the attached file is clicked has been written. An icon identical to that of an authorized document file is used for the attached file so that the attached file is misidentified as a document file. That is, the basic function monitoring unit 231 operates as a program for monitoring an access to the URL.

When the detection technique implemented in the security product as an evaluation target is the suspicious communication monitoring technique, it is monitored whether the basic function is exerted by generated attack communication. Examples of the basic function are RAT manipulations, exchanges with the C & C server, and file uploading. That is, the basic function monitoring unit 231 operates as a program for monitoring whether communication data expected in the course of the attack is exchanged. In the simulated environment 213, a simulated server such as a C & C server is present.

When the detection technique implemented in the security product as an evaluation target is the unauthorized file detection technique, it is monitored whether the basic function is exerted by a generated unauthorized file. Examples of the basic function are program execution, file deletion, communication with the C & C server, and file uploading. That is, the basic function monitoring unit 231 operates as a program for monitoring a process starting with the unauthorized file open and monitoring which operation is performed.

At step S62, the basic function monitoring unit 231 reproduces an attack of the given feature vector in the simulated environment 213.

At step S63, the basic function monitoring unit 231 checks whether a certain time has elapsed. If a certain time has elapsed, the operation of the basic function monitoring unit 231 ends. If a certain time has not elapsed, the process at step S64 is performed.

At step S64, the basic function monitoring unit 231 checks whether the basic function has been detected. If the basic function has been detected, the process at step S65 is performed. If not detected, the process at step S63 is performed again.

At step S65, the basic function monitoring unit 231 registers the attack sample 131 in the evaluation-purpose attack sample database 123. Then, the operation of the basic function monitoring unit 231 ends.

***Description of Effects of Embodiment***

In the present embodiment, the sophisticated attack sample 131 in which a function predicted to be intended by the attacker is kept can be generated. Thus, by using the sophisticated attack sample 131, a security product can be evaluated.

In the present embodiment, adjustment is made so that the feature extracted from the attack sample 131 is close to the normal state model 132. It is checked that the attack sample 131 reproduced from the feature after adjustment keeps the basic function of the attack and is not detected by the detection technique. With this, an effect is acquired in which the sophisticated attack sample 131 that is established as an attack can be automatically generated.

***Other Configurations***

In the present embodiment, the functions of the attack generation unit 111, the comparison unit 112, and the verification unit 113 are implemented by software. However, as a modification example, the functions of the attack generation unit 111, the comparison unit 112, and the verification unit 113 may be implemented by a combination of software and hardware. That is, the functions of the attack generation unit 111, the comparison unit 112, and the verification unit 113 may be partially implemented by a dedicated electronic circuit and the rest may be implemented by software.

The dedicated electronic circuit is a single circuit, composite circuit, programmed processor, parallelly-programmed processor, logic IC, GA, FPGA, or ASIC, for example. “GA” is an abbreviation for Gate Array. “FPGA” is an abbreviation for Field-Programmable Gate Array. “ASIC” is an abbreviation for Application Specific Integrated Circuit.

The processor 101, the memory 102, and the dedicated electronic circuit are collectively referred to as “processing circuitry”. That is, irrespectively of whether the functions of the attack generation unit 111, the comparison unit 112, and the verification unit 113 are implemented by software or a combination of software and hardware, the functions of the attack generation unit 111, the comparison unit 112, and the verification unit 113 are implemented by processing circuitry.

The “device” in the evaluation device 100 may be read as “method”, and the “unit” in the attack generation unit 111, the comparison unit 112, and the verification unit 113 may be read as “step”. Alternatively, the “device” in the evaluation device 100 may be read as “program”, “program product”, or “computer-readable medium having a program recorded thereon”, and the “unit” in the attack generation unit 111, the comparison unit 112, and the verification unit 113 may be read as “procedure” or “process”.

### Embodiment 2

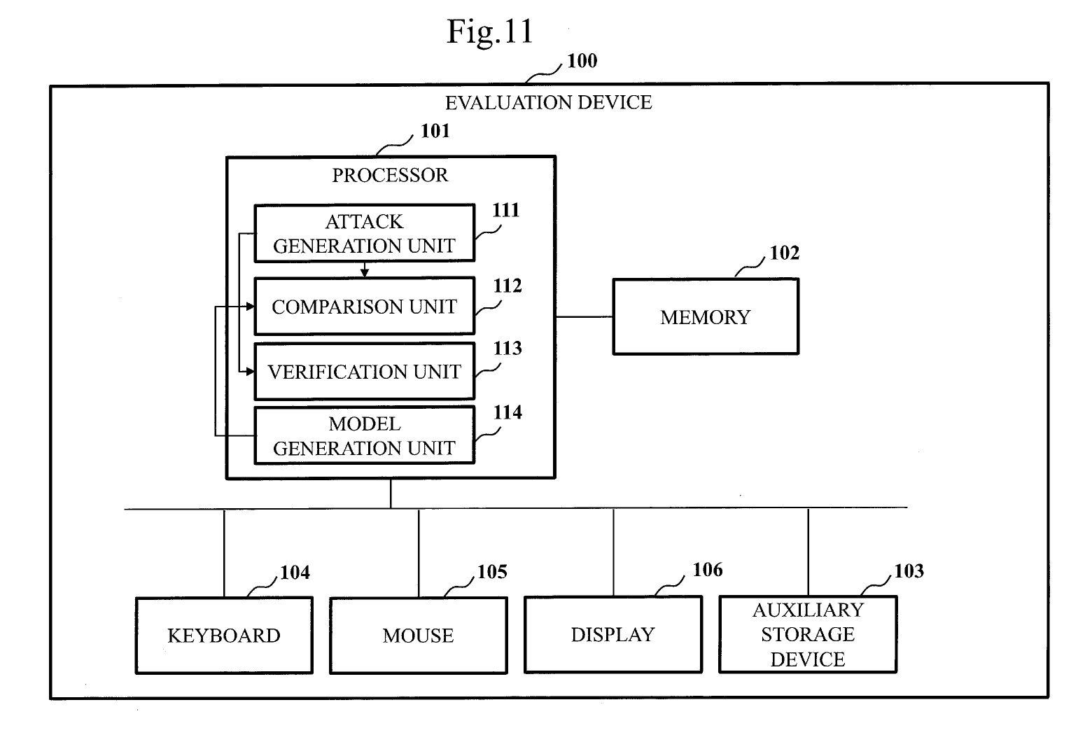

As for the present embodiment, differences from Embodiment 1 are mainly described by using FIG. 11 to FIG. 13.

In Embodiment 1, the normal state model 132 prepared in advance is used as an input. However, in the present embodiment, the normal state model 132 is generated inside the evaluation device 100.

***Description of Configuration***

With reference to FIG. 11, the configuration of the evaluation device 100 according to the present embodiment is described.

The evaluation device 100 includes a model generation unit 114, in addition to the attack generation unit 111, the comparison unit 112, and the verification unit 113 as functional components. The functions of the attack generation unit 111, the comparison unit 112, the verification unit 113, and the model generation unit 114 are implemented by software.

The configuration of the attack generation unit 111 is identical to that of Embodiment 1 illustrated in FIG. 2.

The configuration of the comparison unit 112 is identical to that of Embodiment 1 illustrated in FIG. 3.

The configuration of the verification unit 113 is identical to that of Embodiment 1 illustrated in FIG. 4.

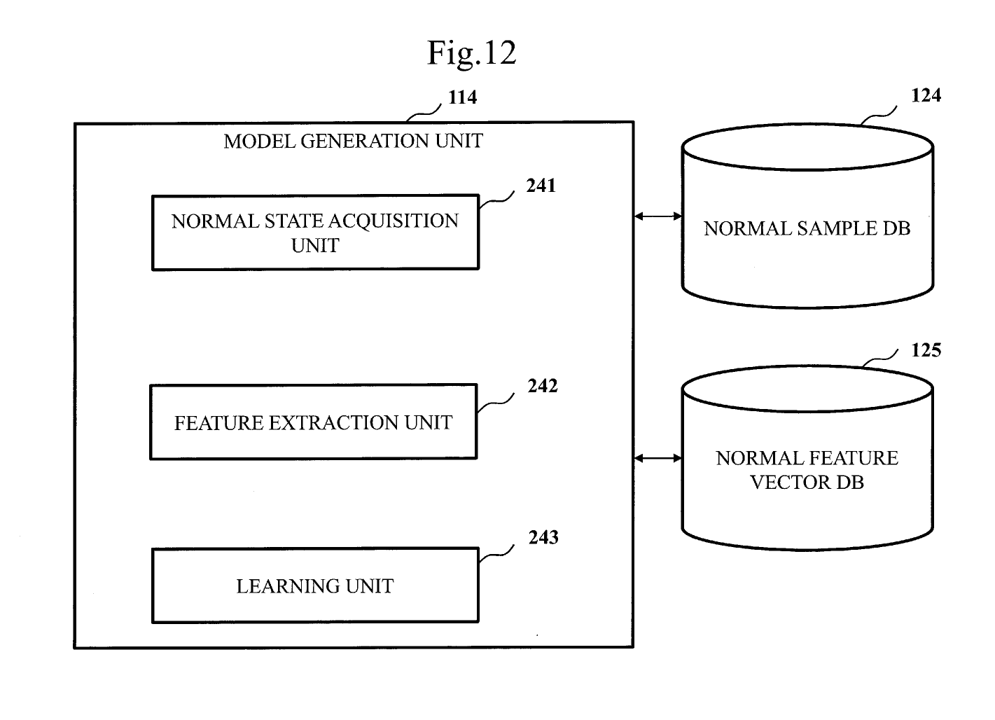

With reference to FIG. 12, the configuration of the model generation unit 114 is described.

The model generation unit 114 has a normal state acquisition unit 241, a feature extraction unit 242, and a learning unit 243.

The model generation unit 114 receives an input of a normal sample 133 from outside.

The model generation unit 114 accesses a normal sample database 124 and a normal feature vector database 125. The normal sample database 124 and the normal feature vector database 125 are constructed in the memory 102 or on the auxiliary storage device 103.

***Description of Operation***

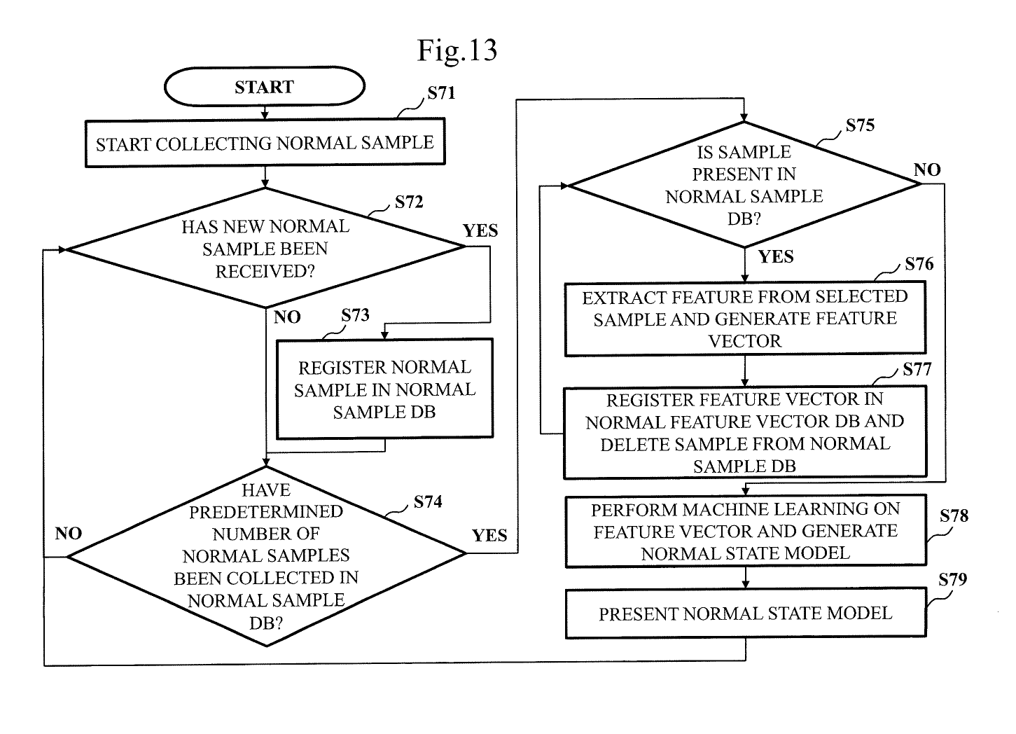

With reference to FIG. 13, the operation of the evaluation device 100 according to the present embodiment is described. The operation of the evaluation device 100 corresponds to a security product evaluation method according to the present embodiment.

FIG. 13 illustrates a flow of operation of the model generation unit 114.

As specifically described in the following, the model generation unit 114 generates the normal state model 132 from the normal sample 133. The normal sample 133 is data having recorded thereon an authorized act on the system that can be an attack target.

From step S71 to step S73, the normal state acquisition unit 241 acquires the normal sample 133 from outside.

Specifically, at step S71, the normal state acquisition unit 241 starts a process of accepting the normal sample 133 monitored by the security product as an evaluation target.

At step S72, the normal state acquisition unit 241 checks whether a new normal sample 133 has been transmitted from a provider organization of the normal sample 133. If a new normal sample 133 has been transmitted, the process at step S73 is performed. If a new normal sample 133 has not been transmitted, the process at step S74 is performed.

At step S73, the normal state acquisition unit 241 registers the newly-accepted normal sample 133 in the normal sample database 124.

At step S74, the feature extraction unit 242 checks whether a certain number of normal samples 133 have been collected in the normal sample database 124. If collected, the process at step S75 is performed. If not collected, the process at step S72 is performed again.

At step S75, the feature extraction unit 242 checks whether the normal sample 133 is present in the normal sample database 124. If the normal sample 133 is present, the process at step S76 is performed. If the normal sample 133 is not present, the process at step S78 is performed.

At step S76, the feature extraction unit 242 extracts the feature of the normal sample 133 acquired by the normal state acquisition unit 241.

Specifically, the feature extraction unit 242 selects the normal sample 133 from the normal sample database 124, extracts the feature from the selected normal sample 133, and create the feature vector C=(c1, c2, . . . , cn).

At step S77, the feature extraction unit 242 registers the created feature vector C in the normal feature vector database 125. The feature extraction unit 242 deletes the normal sample 133 selected at step S76 from the normal sample database 124. Then, the process at step S75 is performed again.

At step S78, the learning unit 243 generates the normal state model 132 by learning the feature extracted from the feature extraction unit 242.

Specifically, the learning unit 243 performs machine learning on the normal state model 132 by using the feature vector registered in the normal feature vector database 125.

At step S79, the learning unit 243 presents the normal state model 132 to the comparison unit 112. Then the process at step S72 is performed again.

In the present embodiment, the model generation unit 114 updates the normal state model 132 every time one or more new normal samples 133 are acquired. At step S12, the comparison unit 112 compares the attack sample 131 generated by the attack generation unit 111 and the latest normal state model 132 generated by the model generation unit 114.

That is, in the present embodiment, every time the predetermined number of normal samples 133 are collected, the normal state model 132 is updated, and the latest normal state model 132 is presented to the comparison unit 112.

***Description of Effects of Embodiment***

In the present embodiment, based on the normal sample 133 regularly or non-regularly sent from the organization, the normal state model 132 is updated to the latest one. With this, an effect is acquired in which the attack sample 131 close to the current normal state can be automatically generated.

***Other Configurations***

In the present embodiment, as with Embodiment 1, the functions of the attack generation unit 111, the comparison unit 112, the verification unit 113, and the model generation unit 114 are implemented by software. However, as with the modification example of Embodiment 1, the functions of the attack generation unit 111, the comparison unit 112, the verification unit 113, and the model generation unit 114 may be implemented by a combination of software and hardware.

### REFERENCE SIGNS LIST

100: evaluation device; 101: processor; 102: memory; 103: auxiliary storage device; 104: keyboard; 105: mouse; 106: display; 111: attack generation unit; 112: comparison unit; 113: verification unit; 114: model generation unit; 121: checked feature vector database; 122: adjusted feature vector database; 123: evaluation-purpose attack sample database; 124: normal sample database; 125: normal feature vector database; 131: attack sample; 132: normal state model; 133: normal sample; 211: attack execution unit; 212: attack module; 213: simulated environment; 221: feature extraction unit; 222: score calculation unit; 223: score comparison unit; 224: feature adjustment unit; 231: basic function monitoring unit; 232: detection technique verification unit; 233: simulated environment; 241: normal state acquisition unit; 242: feature extraction unit; 243: learning unit

1-9. (canceled)

10. An evaluation device comprising:
processing circuitry
to generate an attack sample, which is data for simulating an unauthorized act on a system;
to compare the attack sample generated and a normal state model, which is data acquired by modeling an authorized act on the system, to generate, based on the comparison result, information for generating an attack sample similar to the normal state model, and to feed back the generated information; and
to check whether the attack sample generated by reflecting the information fed back satisfies a requirement for simulating the unauthorized act and to verify, by using the attack sample satisfying the requirement, a detection technique implemented in a security product for detecting the unauthorized act.

11. The evaluation device according to claim 10, wherein
the processing circuitry
extracts a feature of the attack sample generated,
calculates a score indicating a similarity between the feature extracted and a feature of the normal state model, and
increases the similarity by adjusting the feature extracted and generates information indicating a feature after adjustment as information to be fed back, when the score calculated is smaller than a threshold.

12. The evaluation device according to claim 10, wherein
the processing circuitry generates the attack sample by executing an attack module, which is a program for simulating the unauthorized act, and
in case there is non-reflected information generated, the processing circuitry sets a parameter of the attack module in accordance with the non-reflected information and then executes the attack module.

13. The evaluation device according to claim 11, wherein
the processing circuitry generates the attack sample by executing an attack module, which is a program for simulating the unauthorized act, and
in case there is non-reflected information generated, the processing circuitry sets a parameter of the attack module in accordance with the non-reflected information and then executes the attack module.

14. The evaluation device according to claim 10, wherein
the processing circuitry simulates the unauthorized act by using the attack sample satisfying the requirement and checks whether the simulated act is detected by the detection technique and, when not detected, registers the used attack sample as an evaluation-purpose attack sample in a database.

15. The evaluation device according to claim 11, wherein
the processing circuitry simulates the unauthorized act by using the attack sample satisfying the requirement and checks whether the simulated act is detected by the detection technique and, when not detected, registers the used attack sample as an evaluation-purpose attack sample in a database.

16. The evaluation device according to claim 12, wherein
the processing circuitry simulates the unauthorized act by using the attack sample satisfying the requirement and checks whether the simulated act is detected by the detection technique and, when not detected, registers the used attack sample as an evaluation-purpose attack sample in a database.

17. The evaluation device according to claim 13, wherein
the processing circuitry simulates the unauthorized act by using the attack sample satisfying the requirement and checks whether the simulated act is detected by the detection technique and, when not detected, registers the used attack sample as an evaluation-purpose attack sample in a database.

18. The evaluation device according to claim 10, wherein
the processing circuitry generates the normal state model from a normal sample, which is data having the authorized act recorded thereon.

19. The evaluation device according to claim 18, wherein
the processing circuitry
acquires the normal sample from outside,
extracts the feature of the normal sample acquired, and
learns the feature extracted to generate the normal state model.

20. The evaluation device according to claim 18, wherein
the processing circuitry updates the normal state model every time one or more new normal samples are acquired, and
the processing circuitry compares the attack sample generated and a latest normal state model generated.

21. The evaluation device according to claim 19, wherein
the processing circuitry updates the normal state model every time one or more new normal samples are acquired, and
the processing circuitry compares the attack sample generated and a latest normal state model generated.

22. A security product evaluation method comprising:
by processing circuitry, generating an attack sample, which is data for simulating an unauthorized act on a system;
by processing circuitry, comparing the attack sample generated and a normal state model, which is data acquired by modeling an authorized act on the system, generating, based on the comparison result, information for generating an attack sample similar to the normal state model, and feeding back the generated information; and
by processing circuitry, checking whether the attack sample generated by reflecting the information fed back satisfies a requirement for simulating the unauthorized act and verifying, by using the attack sample satisfying the requirement, a detection technique implemented in a security product for detecting the unauthorized act.

23. A non-transitory computer readable medium storing an evaluation program that causes a computer to execute:
an attack generation process of generating an attack sample, which is data for simulating an unauthorized act on a system;
a comparison process of comparing the attack sample generated by the attack generation process and a normal state model, which is data acquired by modeling an authorized act on the system, generating, based on the comparison result, information for generating an attack sample similar to the normal state model, and feeding back the generated information to the attack generation process; and
a verification process of checking whether the attack sample generated by the attack generation process by reflecting the information fed back from the comparison process satisfies a requirement for simulating the unauthorized act and verifying, by using the attack sample satisfying the requirement, a detection technique implemented in a security product for detecting the unauthorized act.
